(19) United States
(12) Patent Application Publication
(10) Pub. No.: US 2023/0085423 A1
(43) Pub. Date: Mar. 16, 2023

(54) PACKET COMMUNICATION SYSTEM, AND ITS TRANSMITTING APPARATUS, RECEIVING APPARATUS, AND PROGRAM

(71) Applicant: NIPPON TELEGRAPH AND TELEPHONE CORPORATION, Tokyo (JP)

(72) Inventors: Takahiro KUBO, Musashino-shi, Tokyo (JP); Natsuki YASUHARA, Musashino-shi, Tokyo (JP); Shinichi YOSHIHARA, Musashino-shi, Tokyo (JP); Yuhei KAWAKAMI, Musashino-shi, Tokyo (JP); Go YAZAWA, Musashino-shi, Tokyo (JP)

(73) Assignee: NIPPON TELEGRAPH AND TELEPHONE CORPORATION, Tokyo (JP)

(21) Appl. No.: 17/904,273

(22) PCT Filed: Feb. 17, 2020
(86) PCT No.: PCT/JP2020/005960

§ 371 Date: Aug. 15, 2022

(51) Int. Cl. H04W 28/04; H04L 1/00; H04L 1/08

(52) U.S. Cl. CPC H04W 28/04; H04L 1/003; H04L 1/08

(57) ABSTRACT

According to one aspect of the disclosure, in a communication apparatus at a transmission end, a packet train that is input is grouped to generate a duplicate packet for each packet group. For each packet group, encoded packets are generated using some packets in a group of duplication source packets and other packets in a group of duplicate packets that do not correspond to the some packets in the group of duplication source packets, and above-described other packets in the duplication source, some packets in the group of duplicate packets that are not used to generate the encoded packets, and the above-described encoded packets are transmitted. On the other hand, in a second communication apparatus at a reception end, the some packets in the group of duplication source packets and the other packets in the group of duplicate packets are decoded based on, among the received packets described above, either the other packets in the group of duplication source packets or the above-described some packets in the group of duplicate packets, and the encoded packets, and when some packets of the packet group are lost in a network, the above-described lost packets are restored by the above-described decoded packets.

### TECHNICAL FIELD

One aspect of the disclosure relates to a system for transmitting packets over a relay network, for example, and relates to a packet communication system for transmitting packets in an uninterruptible manner, a transmission apparatus and a reception apparatus used in the system, and a program used in these apparatuses.

### BACKGROUND ART

In a system that transmits packets between a transmission apparatus and a reception apparatus over a relay network, an uninterruptible network system has been proposed that can transfer packets without losing the packets by transmitting packets of transmission packets and duplicate packets of the transmission packets via different communication paths, respectively (see, for example, PTL 1). According to this system, packets can be transmitted in uninterruptible manner even if packet discard occurs in a relay network, for example, due to communication path switching or bit errors.

There is also proposed a technique of encoding packets at the transmission end using a special encoding scheme, then transmitting the encoded packets via a single communication path, decoding the encoded packets on the reception end, and thereby restoring lost packets (see, for example, PTL 2).

### CITATION LIST

### Patent Literature

PTL 1: JP 4074268 B

PTL 2: JP 2017-228903 A

### SUMMARY OF THE INVENTION

### Technical Problem

However, in the uninterruptible network system disclosed in PTL 1, a plurality of communication paths are used to transmit the same packet. As a result, there is a problem that the consumption of band of the relay network is doubled, leading to an increase in network load.

On the other hand, in the technology disclosed in PTL 2, an increase in network load can be suppressed. However, because a code optimized to reduce image quality variations is used, very complicated processing is required for encoding and decoding, leading to an increase in processing delay. The technique is difficult to be applied to systems requiring simple and low-delay processing, such as, for example, a packet relay transmission system using a wide L2 network.

The present disclosure has been made with reference to the above circumstances, and one aspect of the present disclosure is intended to provide a technique that does not use complicated encoding and decoding processing and allows uninterruptible transmission of packets without using a plurality of communication paths.

### Means for Solving the Problem

To solve the above problem, one aspect of the disclosure is a packet communication system that transmits a packet from a first communication apparatus to a second communication apparatus via a single communication path of a network, in which the first communication apparatus includes a group generation unit that generates a packet group including a first packet and a second packet based on a packet train that is input, a packet duplication unit that generates a first duplicate packet and a second duplicate packet based on the first packet and the second packet included in the packet group, an encoded packet generation unit that generates an encoded packet based on the second packet and the first duplicate packet, and a transmission unit configured to transmit the first packet, the second duplicate packet, and the encoded packet to the single communication path. In addition, the second communication apparatus includes a reception unit that receives the first packet, the second duplicate packet, and the encoded packet that are transmitted via the single communication path, a decoding unit that decodes the second packet and the first duplicate packet based on any one of the first packet and the second duplicate packet that are received and the encoded packet that is received, and a restoring unit that restores the first packet and the second packet of the packet group based on the first packet and the second duplicate packet that are received and the second packet and the first duplicate packet that are decoded.

### Effects of the Invention

According to one aspect of the disclosure, in a first communication apparatus at a transmission end, for example, a packet train that is input is grouped to generate a duplicate packet for each packet group. For each packet group, encoded packets are generated using some packets in a group of duplication source packets and other packets in a group of duplicate packets that do not correspond to the some packets in the group of duplication source packets, and above-described other packets in the duplication source, some packets in the group of duplicate packets that are not used to generate the encoded packets, and the above-described encoded packets are transmitted. On the other hand, in a second communication apparatus at a reception end, for example, the some packets in the group of duplication source packets and the other packets in the group of duplicate packets are decoded based on, among the received packets described above, either the other packets in the group of duplication source packets or the above-described some packets in the group of duplicate packets, and the encoded packets, and when some packets of the above-described packet group are lost in a network, the above-described lost packets are restored by the above-described decoded packets.

That is, according to one aspect of the disclosure, as one aspect thereof, it is possible to provide a technique that allows uninterruptible transmission of packets without using complicated encoding and decoding processing and using a plurality of communication paths.

### BRIEF DESCRIPTION OF DRAWINGS

FIG. 1 is a diagram illustrating an overall configuration of a packet communication system according to an embodiment of the present disclosure.

FIG. 2 is a block diagram illustrating a hardware configuration of an uninterruptible apparatus used in the system illustrated in FIG. 1.

FIG. 3 is a block diagram illustrating a functional configuration of a transmitter of the uninterruptible apparatus used in the system illustrated in FIG. 1.

FIG. 4 is a block diagram illustrating a functional configuration of a receiver of the uninterruptible apparatus used in the system illustrated in FIG. 1.

FIG. 5 is a flowchart illustrating a processing procedure and processing details of packet transmission processing by the transmitter illustrated in FIG. 3.

FIG. 6 is a flowchart illustrating a processing procedure and processing details of packet reception processing by the receiver illustrated in FIG. 4.

FIG. 7 is a diagram illustrating an example of operation of packet transmission processing by the transmitter illustrated in FIG. 3.

FIG. 8 is a diagram illustrating a first example of operation of packet reception processing by the receiver illustrated in FIG. 4.

FIG. 9 is a diagram illustrating a second example of operation of packet reception processing by the receiver illustrated in FIG. 4.

FIG. 10 is a diagram illustrating a first example of a length of a group configured when a packet train is grouped in the transmitter illustrated in FIG. 3.

FIG. 11 is a diagram illustrating a second example of a length of a group configured when a packet train is grouped in the transmitter illustrated in FIG. 3.

FIG. 12 is a diagram illustrating an example of effects of the packet communication system according to an embodiment of the present disclosure.

FIG. 13 is a diagram illustrating a problem of a system transmitting the same packet via two different communication paths.

### DESCRIPTION OF EMBODIMENTS

Hereinafter, embodiments of the present disclosure will be described with reference to the drawings.

### Embodiment

### Configuration Example

### (1) System

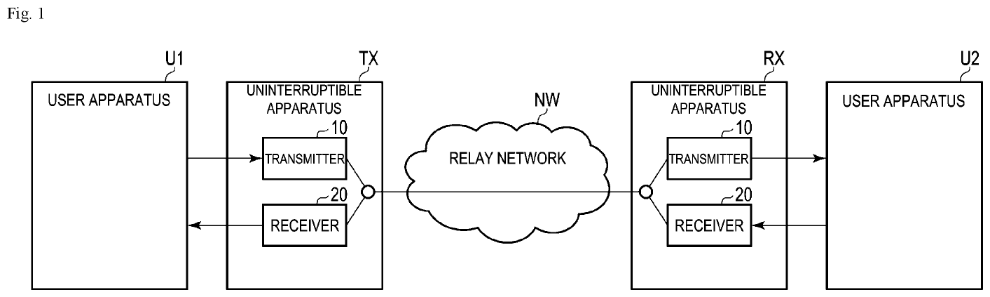

FIG. 1 is a diagram illustrating an overall configuration of a packet communication system according to an embodiment of the present disclosure.

The system is configured to transmit packets over a single communication path of a relay network NW between an uninterruptible apparatus TX (first communication apparatus) to which a user apparatus U1 is connected and an uninterruptible apparatus RX (second communication apparatus) to which a user apparatus U2 is connected.

The user apparatuses U1, U2 may be directly connected to the uninterruptible apparatuses TX, RX, and may be indirectly connected to the uninterruptible apparatuses TX, RX via another communication apparatus or a network. The relay network NW can be any type of network, such as wired or wireless, as long as the relay network NW can transmit packets.

### (2) Apparatus

The uninterruptible apparatuses TX, RX include, for example, a gateway or router, and both include a transmitter 10 and a receiver 20.

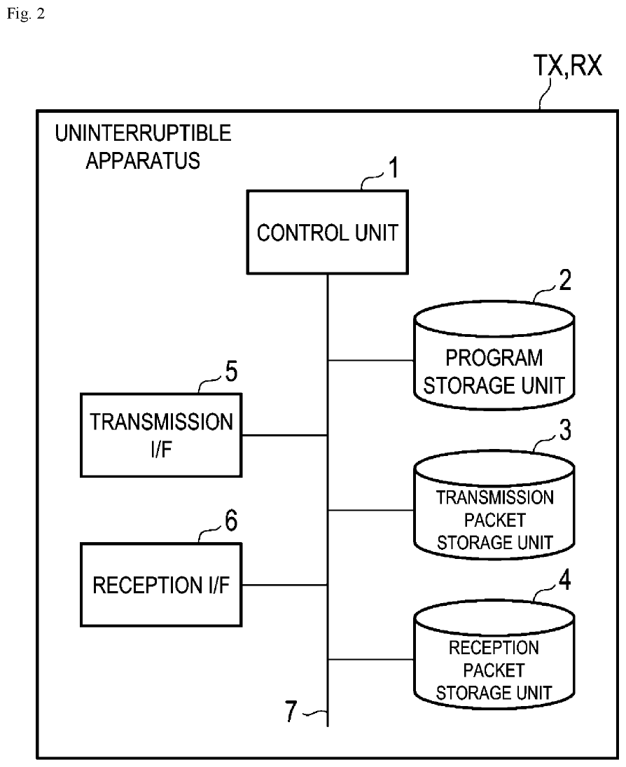

FIG. 2 is a block diagram illustrating a hardware configuration of the uninterruptible apparatuses TX, RX. As illustrated in FIG. 2, the uninterruptible apparatuses TX, RX includes a control unit 1 including a hardware processor, such as a central processing unit (CPU). A program storage unit 2, a transmission packet storage unit 3, and a reception packet storage unit 4 are connected to the control unit 1 via the bus 7, and a transmission interface unit (transmission I/F) 5 and a reception interface unit (reception I/F) 6 are further connected to the control unit 1.

The program storage unit 2 is, for example, a non-volatile memory such as a hard disk drive (HDD) or a solid state drive (SSD) that is readable and writable at any time, working as a main storage medium. The program storage unit 2 stores, in its storage area, a middleware such as an operation system (OS), and a program configured to execute a variety of processing operations according to the embodiment of the present disclosure. Note that, as the storage medium, the HDD or the SSD described above may be combined with a read only memory (ROM).

The transmission packet storage unit 3 and the reception packet storage unit 4 are, for example, a combination of an HDD or an SSD, and a random access memory (RAM), and a working storage area used to perform various operations and controls on packets and a plurality of transmission and reception buffer storage units are provided in a storage area of the transmission packet storage unit 3 and the reception packet storage unit 4. The transmission and reception buffer storage unit operates as a so-called first in-first out (FIFO) queue that stores and reads packets in chronological order.

The transmission I/F 5 and the reception I/F 6 perform signal processing for communication, such as, for example, modulation and demodulation, on the transmission packet and the reception packet.

### (2-1) Transmitter 10

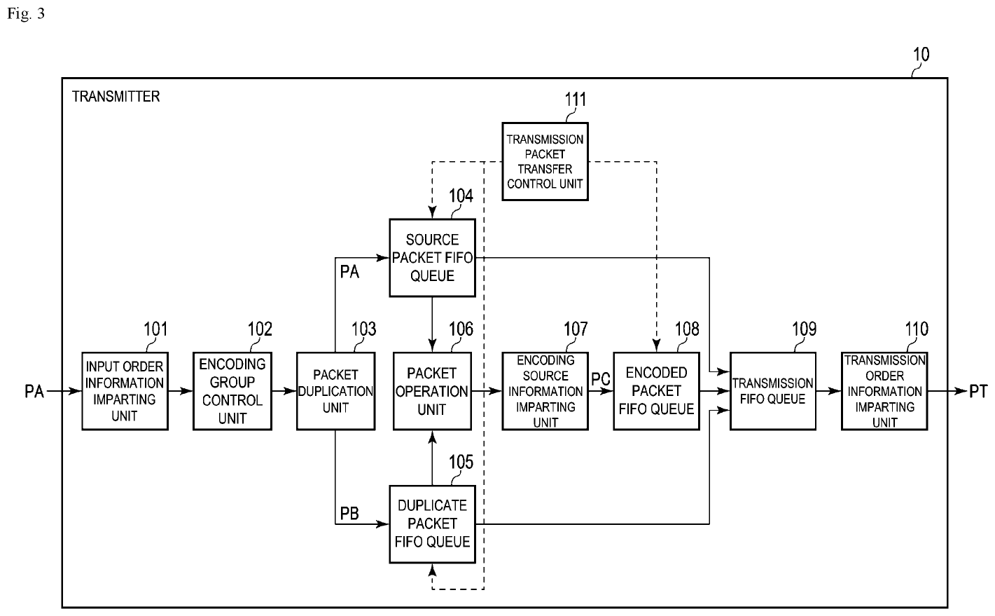

FIG. 3 is a block diagram illustrating a functional configuration of the transmitter 10. The transmitter 10 includes an input order information imparting unit 101, an encoding group control unit 102, a packet duplication unit 103, a source packet FIFO queue 104, a duplicate packet FIFO queue 105, a packet operation unit 106, an encoding source information imparting unit 107, an encoded packet FIFO queue 108, a transmission FIFO queue 109, a transmission order information imparting unit 110, and a transmission packet transfer control unit 111.

Of these, the input order information imparting unit 101, the encoding group control unit 102, the packet duplication unit 103, the packet operation unit 106, the encoding source information imparting unit 107, the transmission order information imparting unit 110, and the transmission packet transfer control unit 111 are implemented by a hardware processor executing a program stored in the program storage unit 2.

The input order information imparting unit 101 imparts a number to each packet in order of input, with respect to the packet train PA input from the user apparatuses U1, U2. The above-described number is referred to as input order information. The input order information is imparted to, for example, a header or a payload of a packet.

The encoding group control unit 102 groups the packet train PA to which the above-described input order information is imparted, for each of a plurality of preset number of packets n (n>2). The length of the above-described group described above is set to a length not below the maximum value of the interruption time that has occurred in the past, in the relay network NW. The setting example will be described in detail below.

The packet duplication unit 103 generates, for each packet group generated by the above-described encoding group control unit 102, n duplicate packets PB corresponding to the n packets PA that constitute the group. Hereinafter, n packets that are the source for duplication are referred to as source packets.

The source packet FIFO queue 104 stores the n source packets output from the above-described packet duplication unit 103 in input order and reads out in input order. The duplicate packet FIFO queue 105 likewise stores n duplicate packets output from the above-described packet duplication unit 103 in input order and read in input order.

The packet operation unit 106 combines a portion of the source packets stored in the above-described source packet FIFO queue 104 and other portion of the duplicate packets stored in the above-described duplicate packet FIFO queue 105, and performs predetermined encoding operation to generate an encoded packets having the same packet length as that of the above-described source packets and the duplicate packets. For encoding, for example, a linear code is used. More specifically, an encoding scheme using packet operation rules defined by considering the source packet of any m bits and the duplicate packets of m bits as Galois fields of GF(2^{m}) is used.

The encoding source information imparting unit 107 imparts, to the encoded packet generated by the above-described packet operation unit 106, input order information of the source packet and input order information of the duplicate packet that are used in the encoding operation. The input order information for the source packet and the duplicate packet is referred to as encoding source information.

The encoded packet FIFO queue 108 stores the encoded packets PC output from the above-described encoding source information imparting unit 107 in input order according to the encoding source information and reads the encoded packets PC in input order. The above-described transmission FIFO queue 109 receives and stores the source packets PA, duplicate packets PB, and encoded packets PC respectively read from the above-described source packet FIFO queue 104, the duplicate packet FIFO queue 105, and the encoded packet FIFO queue 108 in read order and reads out the packets in input order.

The transmission order information imparting unit 110 imparts a number indicating the transmission order to each header of the source packets PA, the duplicate packets PB, and the encoded packets PC read from the above-described transmission FIFO queue 109. The number indicating the transmission order is referred to as transmission order information. The transmission order information imparting unit 110 outputs each packet to which the above-described transmission order information is imparted to the transmission I/F 5 as a transmission packet train PT.

The transmission packet transfer control unit 111 selects source packets and duplicate packets to be encoded by controlling the read timing of each of the source packets and duplicate packets from the above-described source packet FIFO queue 104 and the duplicate packet FIFO queue 105, respectively. The transmission packet transfer control unit 111 also selects the source packets PA, the duplicate packets PB, and the encoded packets PC to be transmitted by controlling the read order of each packet from the above-described source packet FIFO queue 104, the duplicate packet FIFO queue 105, and the encoded packet FIFO queue 108, respectively, and further specifies the transmission order.

### (2-2) Receiver 20

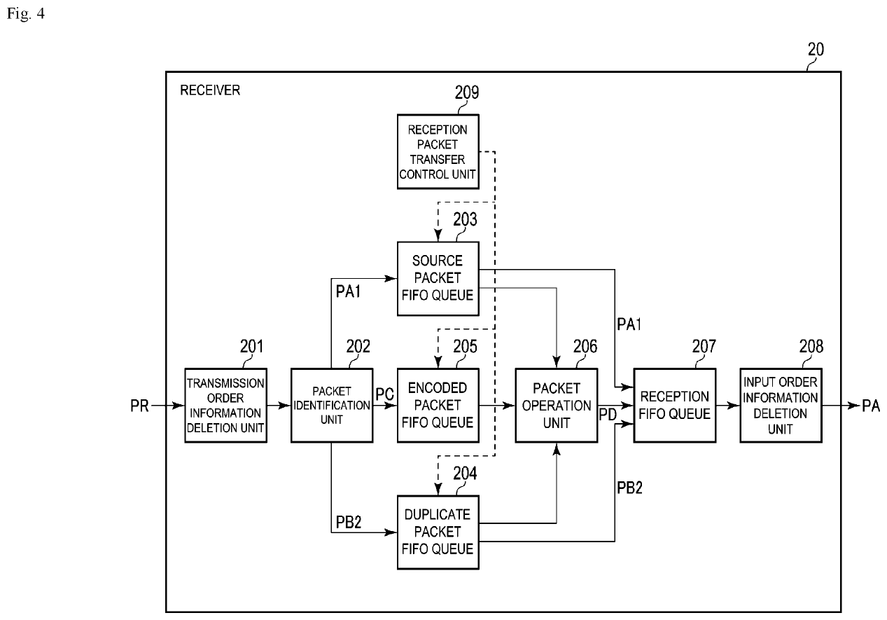

FIG. 4 is a block diagram illustrating a functional configuration of the receiver 20. The receiver 20 includes a transmission order information deletion unit 201, a packet identification unit 202, a source packet FIFO queue 203, a duplicate packet FIFO queue 204, an encoded packet FIFO queue 205, a packet operation unit 206, a reception FIFO queue 207, an input order information deletion unit 208, and a reception packet transfer control unit 209.

Of these, the transmission order information deletion unit 201, the packet identification unit 202, the packet operation unit 206, the input order information deletion unit 208, and the reception packet transfer control unit 209 are implemented by a hardware processor executing a program stored in the program storage unit 2.

The transmission order information deletion unit 201 deletes the transmission order information from each packet header of the reception packet train PR received by the reception I/F 6, and inputs each received packet from which the transmission order information has been deleted to the packet identification unit 202.

The packet identification unit 202 identifies the above-described reception packet PR that is input to either the source packet, the duplicate packet, or the encoded packet. The packet identification unit 202 then outputs the source packet to the source packet FIFO queue 203, the duplicate packet to the duplicate packet FIFO queue 204, and the encoded packet to the encoded packet FIFO queue 205. An example of a method for identifying a packet is described below.

The source packet FIFO queue 203 stores the source packets identified by the above-described packet identification unit 202 in input order and reads the source packets in input order. The duplicate packet FIFO queue 204 stores the duplicate packets identified by the above-described packet identification unit 202 in input order and reads the duplicate packets in input order. The encoded packet FIFO queue 205 stores the encoded packets identified by the above-described packet identification unit 202 in input order and reads the encoded packets in input order.

The packet operation unit 206 performs a decoding operation on the encoded packet read from the encoded packet FIFO queue 205 based on any one of the source packet read from the source packet FIFO queue 203 and the duplicate packet read from the duplicate packet FIFO queue 204, thereby decoding a portion of the source packets and a portion of the duplicate packets to be encoded in the transmitter 10 at the transmission end.

The reception FIFO queue 207 stores the source packets read from the above-described source packet FIFO queue 203, the duplicate packets read from the duplicate packet FIFO queue 204, and the source packets and duplicate packets decoded by the packet operation unit 206 in input order and read out the packets in input order.

The input order information deletion unit 208 deletes the input order information from the header of each packet read out from the reception FIFO queue 207, and outputs each packet after deletion to the user apparatuses U1, U2 as the restored packet train PA.

The reception packet transfer control unit 209 performs the processing below by controlling the reading of each packet from the above-described source packet FIFO queue 203, the duplicate packet FIFO queue 204 and the encoded packet FIFO queue 205. The reception packet transfer control unit 209 performs processing of providing a combination of packets to be decoded to the packet operation unit 206, and processing of selecting packets for constituting restored packets from among the source packet, the duplicate packet, and the decoded packet, and processing of inputting the selected packets to the reception FIFO queue 207.

### Operation Example

Next, a packet communication operation by the packet communication system configured as described above will be described.

An example will be described in which the packet train PA transmitted from the user apparatus U1 is transmitted from the uninterruptible apparatus TX to the uninterruptible apparatus RX via the relay network NW and is transferred from the uninterruptible apparatus RX to the user apparatus U2.

### (1) Operation of Transmitter 10 of Uninterruptible Apparatus TX

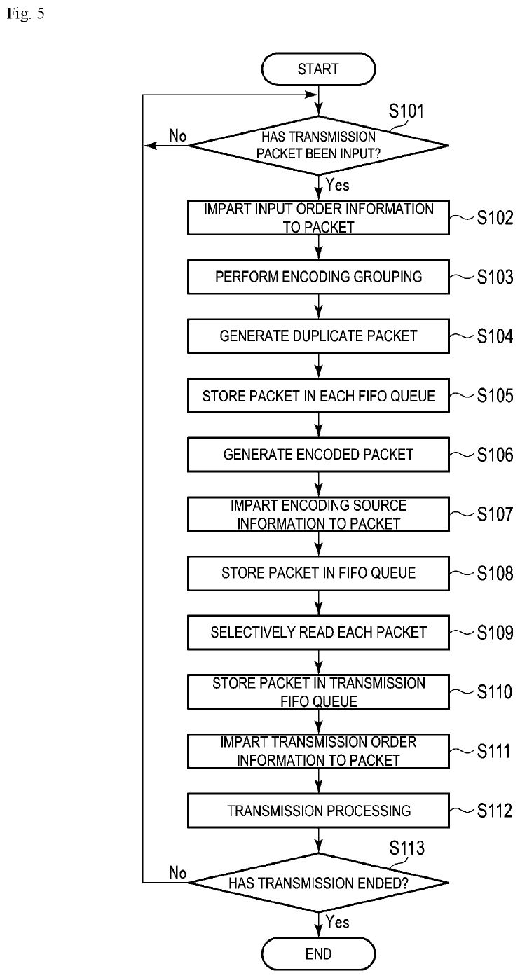

FIG. 5 is a flowchart illustrating a control procedure and control details by the transmitter 10 of the uninterruptible apparatus TX.

### (1-1) Grouping of Packet Train

In the uninterruptible apparatus TX, the transmitter 10 monitors the input of the transmission packet train PA in step S101. In this state, when the transmission packet train PA transmitted from the user apparatus U1 is input, in step S102, the transmitter 10 first imparts, by the input order information imparting unit 101, input order information to each packet of the above-described transmission packet train PA that is input. Next, in step S103, the transmitter 10 groups the packet train to which the above-described input order information has been imparted, for each of n packets by the encoding group control unit 102.

An example of a method for determining the length of the above-described group will be described.

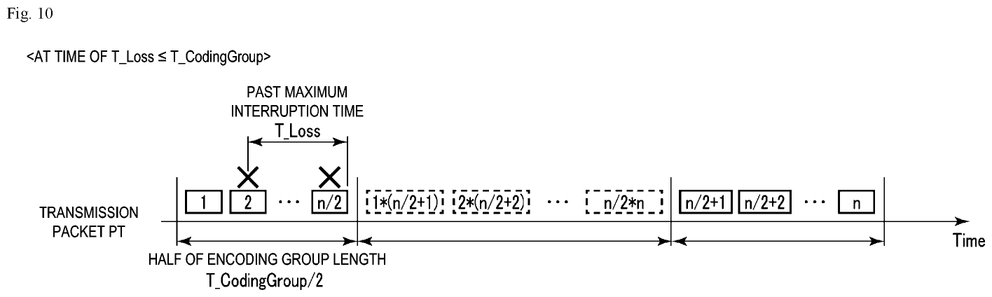

For example, as illustrated in FIG. 10, when interruption of maximum T_{Loss}(s) occurs in the relay network NW, assuming that a group length is T_{CodingGroup}(s), the following relationship is required to be satisfied to achieve uninterruptible packet transmission.

T_{Loss≤}T_{CodingGroup}

In the embodiment, the length of the packet groups is set to satisfy the relationship described above. As a result, since 1 to n packets including encoded packets are always received, even if the interruption of the above-described maximum T_{Loss}(s) occurs, all packets in the group can be restored.

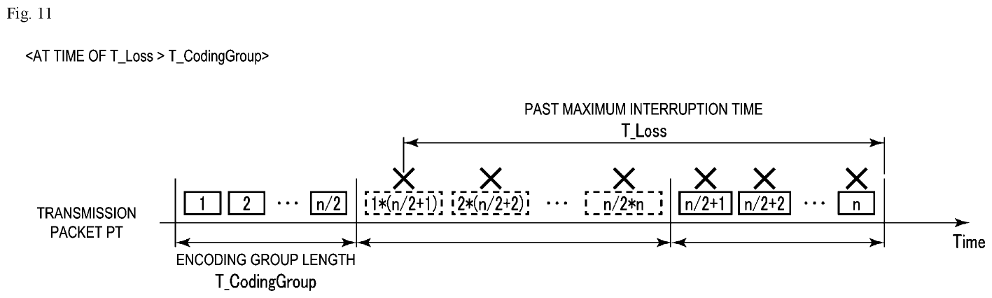

Incidentally, for example, as illustrated in FIG. 11, when the relationship between T_{Loss}(s) and the length of the group T_{CodingGroup}(s) becomes

T_{Loss}>T_{CodingGroup},

the interruption time is longer than the length of the packet group, so that all of the 1 to n packets including the encoded packets cannot be received and uninterruptible packet transmission cannot be performed.

That is, the length of the packet group is set to a value not below the maximum value of the interruption time that has occurred in the past. It is also contemplated that the maximum value of the interruption time of the relay network NW is further changed after determining the length of the above-described packet group. Thus, for example, the length of the interruption time of the relay network NW is monitored after the determination of the length of the packet group described above. Then, it is sufficient that processing of setting again the length of the above-described packet group every time preset time has elapsed or when the detected interruption time length exceeds the past maximum interruption time length.

### (1-2) Generation of Duplicate Packet

In step S104, the transmitter 10 then generates n duplicate packets PB of the same content, including a header portion, for the grouped n packets PA described above by the packet duplication unit 103. Then, in step S105, the transmitter 10 sequentially inputs and stores the above-described n packets (source packets) that is the source of the duplication in the source packet FIFO queue 104. As similar to this, the transmitter 10 sequentially inputs and stores the above-described generated n duplicate packets in the duplicate packet FIFO queue 105.

### (1-3) Generation of Encoded Packet

In step S106, the transmitter 10 then performs an encoding operation by the packet operation unit 106 to generate the encoded packet PC based on a portion of the above-described source packets PA and another portion of the duplicate packets PB.

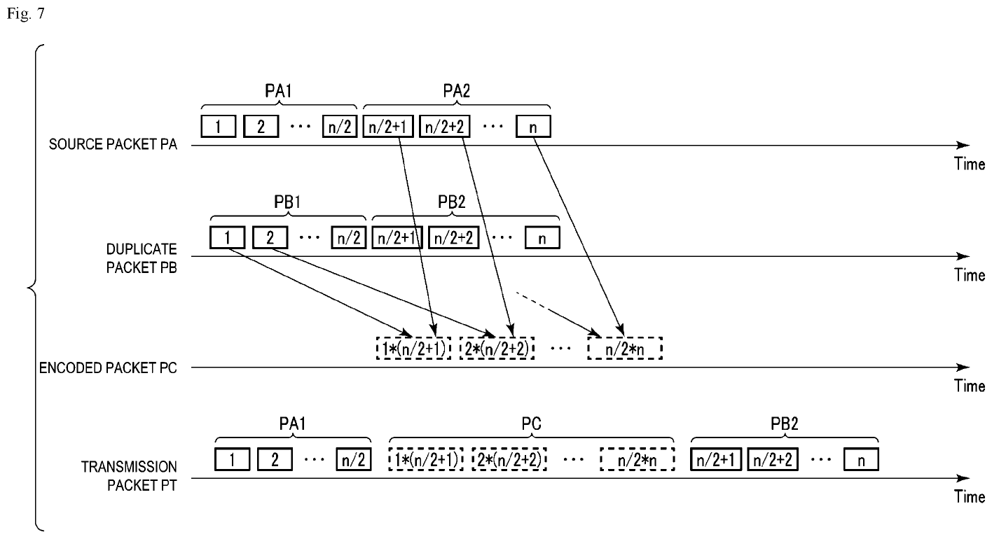

For example, under the control of the transmission packet transfer control unit 111, in one packet group, the source packet train PA is divided into a packet train PA1 of n/2 packets (number 1 to n/2) that is the first half and a packet train PA2 of n/2 packets (number n/2+1 to n) that is the latter half, as illustrated in FIG. 7. As similar to this, the duplicate packet train PB is divided into a packet train PB1 of n/2 packets (number 1 to n/2) that is the first half and a packet train PB2 of n/2 packets (number n/2+1 to n) that is the latter half.

Then, for example, the source packet train PA2 of n/2 packets that is the latter half are read from the source packet FIFO queue 104, and duplicate packet train PB1 of n/2 packets that is the first half are read from the duplicate packet FIFO queue 105. Then, the packet operation unit 106 performs linear encoding using packet operation rules defined by regarding the read source packet train PA2 of n/2 packets and the read duplicate packet train PB1 of n/2 packets described above as a Galois field of GF(2^{m}), for example, to generate n/2 encoded packets PC. These encoded packets are represented in FIG. 7 by 1*(n/2+1), 2*(n/2+2), . . . , n/2*n.

The combination of the source packets and the duplicate packets in encoding may be, for example, the source packet train PA1 of n/2 packets that is the first half and the duplicate packet train PB2 of n/2 packets that is the latter half.

Once the above-described encoded packets PC are generated, then, in step S107, the transmitter 10 subsequently imparts input order information of the source packets and input order information of the duplicate packets to the generated encoded packets PC described above as encoding source information, by the encoding source information imparting unit 107. As the imparting method, for example, a method is used in which the above-described entire encoded packet is regarded as a payload, a new header is imparted, the result is encapsulated, and the above-described encoding source information is imparted to the above-described new header together with transmission destination information and the transmission source information.

In step S108, the encoding source information imparting unit 107 inputs the encoded packets PC to which the above-described encoding source information has been imparted to the encoded packet FIFO queue 108 and causes the encoded packet FIFO queue 108 to store the encoded packets PC to which the encoding source information has been imparted.

### (1-4) Generation and Transmission of Transmission Packet Train PT

Then, in step 5109, the transmitter 10 selectively reads the source packets PA, the duplicate packets PB, and the encoded packets PC by controlling the reading timing of each packet from the above-described source packet FIFO queue 104, the duplicate packet FIFO queue 105, and the encoded packet FIFO queue 108, respectively, under the control of the transmission packet transfer control unit 111, and generates the transmission packet train PT.

For example, as illustrated in FIG. 7, first, n/2 source packets PA1 of the first half are read from the source packet FIFO queue 104, then the encoded packets PC are read from the encoded packet FIFO queue 108, and finally n/2 duplicate packets PB2 of the latter half are read from the duplicate packet FIFO queue 105. In step S110, each read packet is input to and stored in the transmission FIFO queue 109 in order.

In step S111, the transmitter 10 imparts transmission order information indicating the transmission order to each header of the source packets PA1, the encoded packets PC, and the duplicate packets PB2 read from the above-described transmission FIFO queue 109, by the transmission order information imparting unit 110. The transmission order information imparting unit 110 outputs each packet to which the above-described transmission order information is imparted to the transmission I/F 5 as a transmission packet train PT. As a result, the above-described transmission packet train PT is transmitted from the transmission I/F 5 to the uninterruptible apparatus RX at the reception end according to the communication protocol of the relay network NW.

### (2) Operation of Receiver 20 of Uninterruptible Apparatus RX

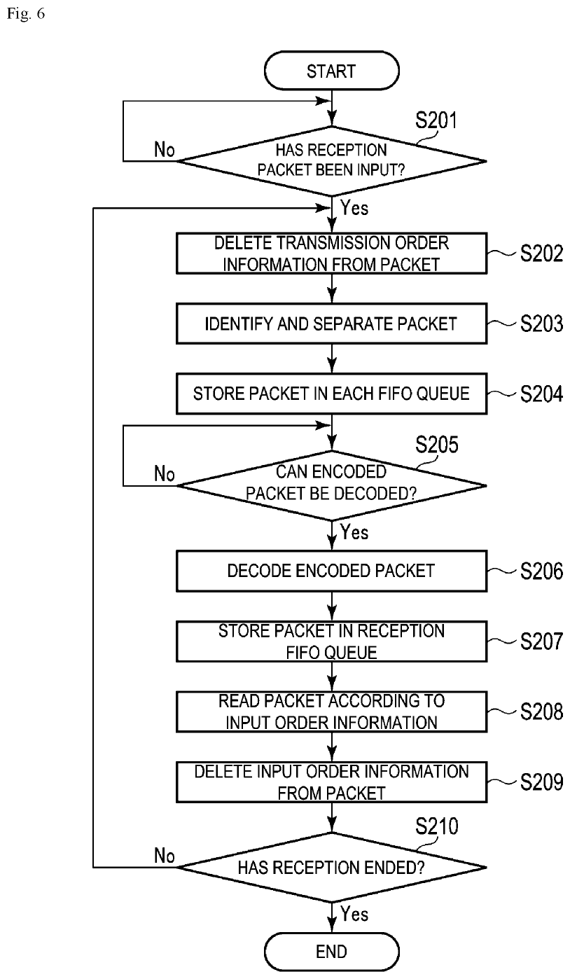

FIG. 6 is a flowchart illustrating a control procedure and control details by the receiver 20 of the uninterruptible apparatus RX.

### (2-1) Reception of Reception Packet Train and Separation of Packets

In step S201, in the uninterruptible apparatus RX, the receiver 20 monitors the reception of the reception packet train PR. In this state, when the reception packet train PR that constitutes the packet group is received by the reception I/F 6, in step S202, the receiver 20 first deletes the transmission order information from the header of each packet of the above-described reception packet train PR by the transmission order information deletion unit 201.

In step S203, the receiver 20 identifies whether each packet included in the above-described reception packet train PR is the source packet, the duplicate packet, or the encoded packet, and separates packets, by the packet identification unit 202. As an identification method, for example, a method is used in which a packet type determination field is provided in a specific field of a header or a payload of a packet, a bit sequence indicating the packet type is inserted into the packet type determination field at the transmitter 10 end and transmitted, and the above-described packet identification unit 202 of the receiver 20 extracts and decodes the above-described bit sequence to identify the type of the packet.

In step S204, the receiver 20 inputs the source packet PA1 to the source packet FIFO queue 203, the encoded packet PC to the encoded packet FIFO queue 205, and the duplicate packet to the duplicate packet FIFO queue 204 and causes the source packet FIFO queue 203, the encoded packet FIFO queue 205, and the duplicate packet FIFO queue 204 to store the source packet PA1, the encoded packet PC, and the duplicate packet, respectively, based on the identification result by the above-described packet identification unit 202.

### (2-2) Decoding of Encoded Packet

In step S205, the receiver 20 determines whether the encoded packet PC can be decoded. In this state, when the encoded packet PC is stored in the encoded packet FIFO queue 205, in step S206, the receiver 20 performs packet operation processing for packet decoding as below by the packet operation unit 206.

That is, the packet operation unit 206 sequentially reads the encoded packets PC stored in the above-described encoded packet FIFO queue 205 from the leading packet. In parallel with this, the source packets or the duplicate packets whose input order information corresponds to input order information of the above-described read encoded packets PC are sequentially read from the source packet FIFO queue 203 or the duplicate packet FIFO queue 204. Then, the packet operation for decoding is performed between the read packets, thereby decoding the source packets or the duplicate packets.

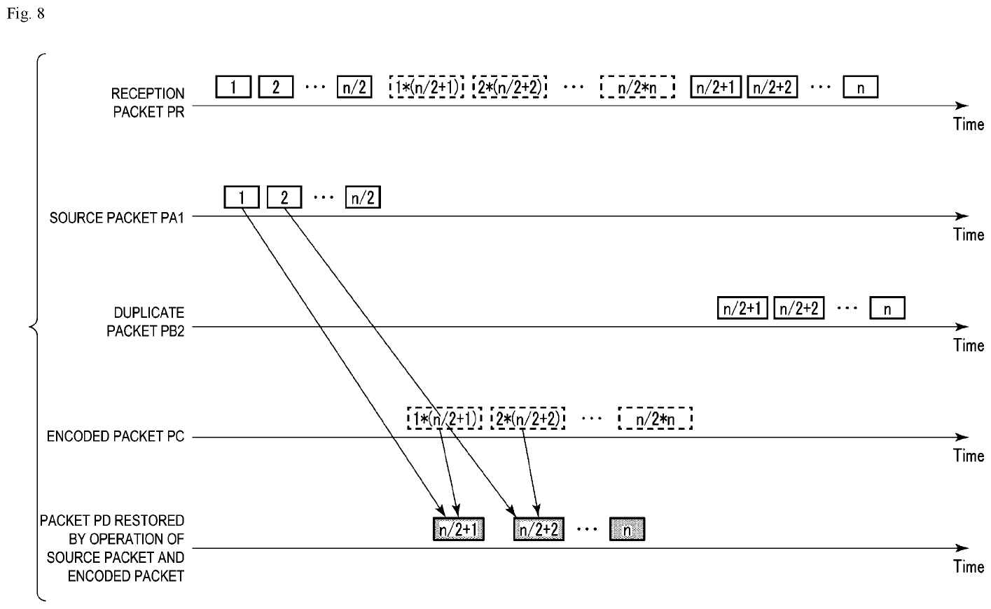

As a result, for example, as illustrated in FIG. 8, when the encoded packets PC, the source packets PA1, and the duplicate packets PB2 are received, the packet operation is performed based on, for example, the source packets PA1 and the encoded packets PC, and the packets PD that are equivalent to the duplicate packets PB2 are decoded.

When interruption does not occur in the relay network NW and both the source packets PA1 and the duplicate packets PB2 are received as in the case of FIG. 8, the above-described decoding processing may be omitted. As a result, the processing load of the receiver 20 can be reduced to reduce transmission delay.

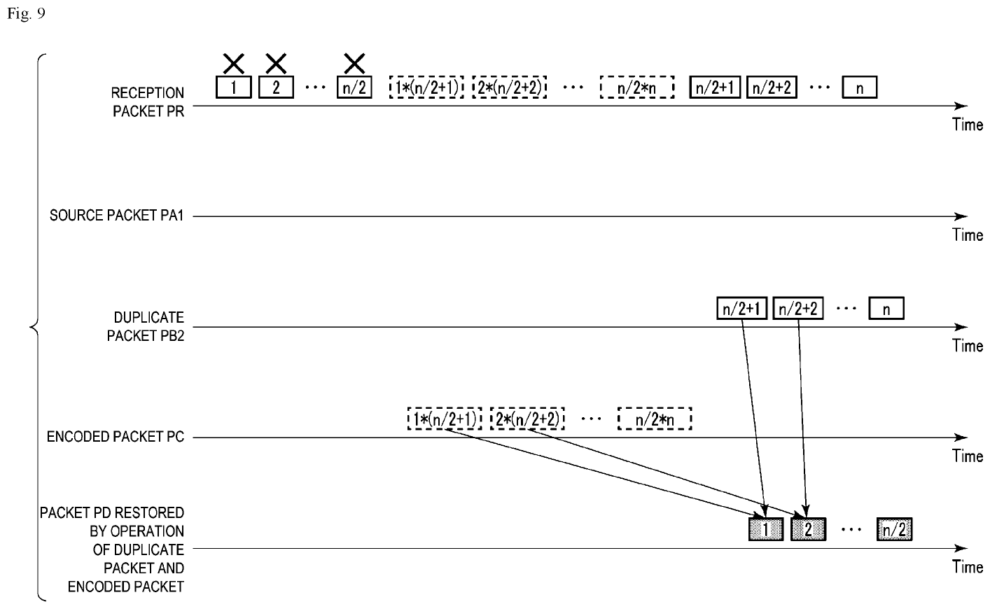

On the other hand, for example, as illustrated in FIG. 9, it is assumed that the source packets PA1 of the reception packet train PR is not received due to interruption of the relay network NW. In this case, the packet operation unit 206 performs the packet operation based on the received duplicate packets PB2 and the encoded packets PC described above, and the packets PD that are equivalent to the source packets PA1 are decoded.

Even when the duplicate packets PB2 of the reception packet train PR is not received, the packets PD that are equivalent to the duplicate packets PB2 are likewise decoded based on the received source packets PA1 and the encoded packets PC.

In step S207, under the control of the reception packet transfer control unit 209, the receiver 20 reads the source packets, the duplicate packets, and the decoded packets from the source packet FIFO queue 203, the duplicate packet FIFO queue 204, and the packet operation unit 206, respectively, according to the input order information, inputs the source packets, the duplicate packets, and the decoded packets to the reception FIFO queue 207, and causes the reception FIFO queue 207 to store the source packets, the duplicate packets, and the decoded packets.

### (2-3) Output of Reception Packet

In step S208, the receiver 20 sequentially reads reception packet train including the restored packets PD from the above-described reception FIFO queue 207. In step S209, the input order information deletion unit 208 deletes the input order information from the header of each of the read packets described above. The packet train PA from which input order information has been deleted is transmitted to the transmission destination user apparatus U2.

When the above-described reception decoding processing of the one packet group ends, in step S210, the receiver 20 determines whether the reception of the packet train PR ends. Then, in a case where the reception of the reception packet train PR is continued, the process returns to step S202, and the above-described processing operations of (2-1) to (2-3) are repeated. On the other hand, if reception of the reception packet PR has ended, the operation ends, and the processing returns to the standby state in step S201.

### Effects

As described above, in the embodiment, in the uninterruptible apparatus TX serving as the transmission end, the transmitter 10 generates the packet group including the plurality of packets PA1, PA2 based on the input transmission packet train PA. The length of the packet group is set to a length not below the maximum value of the interruption time that has occurred in the past, in the relay network NW. The transmitter 10 generates duplicate packets PB1, PB2 corresponding to packets PA1, PA2 included in the group for each of the packet groups described above, generates the encoded packets PC based on a portion PB1 of the duplicate packets and another portion PA2 of the source packets, and transmits the portion PA1 of the source packets, another portion PB2 of the duplicate packets, and the encoded packets PC, described above, to relay network NW. On the other hand, in the receiver 20 of the uninterruptible apparatus RX serving as the reception end, when the source packets PA1, the duplicate packets PB2, and the encoded packets PC, described above, are received, the duplicate packets PB2 or the source packet PA1, described above, is decoded based on the encoded packets PC and either the source packets PA1 or the duplicate packets PB2 described above.

Accordingly, even if interruption occurs in the relay network NW, and either the source packets PA1 or the duplicate packets PB2 are not received, it is possible to restore the unreceived packet based on the encoded packets PC.

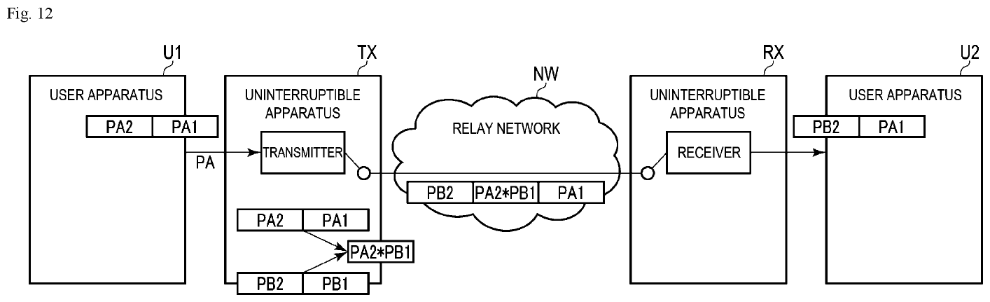

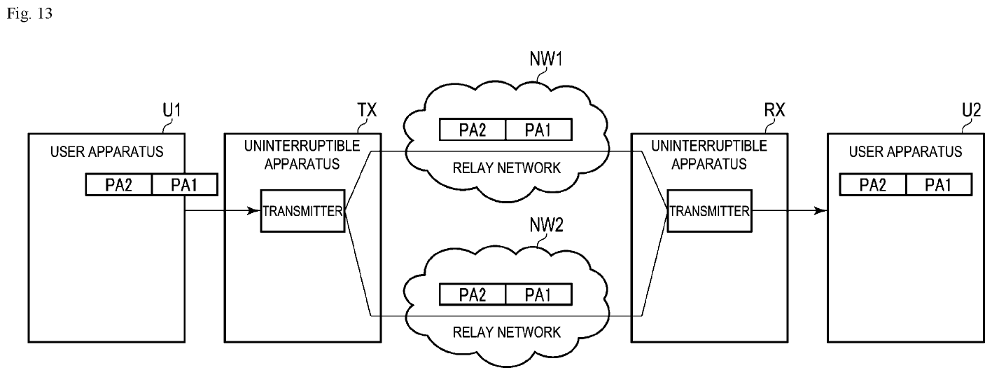

That is, according to the embodiment, for example, as illustrated in FIG. 12, if only three groups of packets (each including n/2 packets) including the source packets PA1, the duplicate packets PB2, and the encoded packets PC are transmitted and the interruption time is less than the length of the packet group, uninterrupted packet transmission can be achieved. In a related-art system, the groups of packets PA1, PA2 are transmitted by the communication paths of two systems, as illustrated in FIG. 13, thereby the four groups of packets are transmitted, which leads to an increase in network load.

According to the embodiment, because the encoding scheme used for generating the encoded packet is a relatively simple encoding scheme using a linear code, for example, the processing load of the uninterruptible apparatus can be suppressed to be low as compared with the case of using a complicated encoding scheme used for related-art video data transmission.

### Modified Examples

(1) In the above-described embodiment, an example has been described of a case in which a packet train in which the length of each packet is fixed is transmitted from the user apparatus U1. On the other hand, it is also conceivable that the length of each packet in the packet train transmitted from the user apparatus U1 is variable. In this case, a packet length adjusting unit is arranged in the anterior stage of the transmitter 10 of the uninterruptible apparatus TX, and the packet length adjusting unit adjusts the packet length so that the lengths of the respective packets of the packet train become equal. As a method of adjusting packet length, for example, a method may be used in which padding is added for each packet so that the length of the packet becomes a preset constant length according to the length of that packet. By making the packet length constant in this manner, the present disclosure can be implemented even in a case where the packet operation unit 106 performs the encoding operation of the packet using a linear code as in the embodiment.

(2) In the above-described embodiment, a case where an encoded packet is generated from a source packet and one duplicate packet generated from the source packet, and the generated encoded packets are transmitted together with a portion of the source packets and another portion of the duplicate packets, described above, has been described as an example. However, the disclosure is not limited thereto, and a plurality of duplicate packets may be generated from the source packet, a plurality (for example, two) of encoded packets are generated based on the generated plurality of duplicate packets and the source packet, and the generated plurality of encoded packets may be transmitted together with a portion of the source packets and another portion of the duplicate packets, described above. In this way, even if one encoded packet and a portion of the source packets or another portion of the duplicate packets cannot be received by the uninterruptible apparatus RX at the reception end due to interruption of the relay network, it is possible to reproduce all of the source packets.

(3) In addition, the configuration, the processing procedure, and the processing details of the uninterruptible apparatus, the length of the group, the encoding scheme used to generate the encoded packets, the transmission order of the source packets, the duplicate packets, and the encoded packets used to generate the transmission packet, the type of relay network, and the like can be variously modified and implemented without departing from the gist of the present disclosure.

That is, the disclosure is not limited to the above embodiment and can be variously modified in the implementation stage without departing from the gist of the present disclosure. Also, the embodiments may appropriately be performed in combination as long as possible, and in such a case, combined effects can be obtained. Further, the above embodiment includes the disclosures in various stages, and various disclosures can be extracted from appropriate combinations of a plurality of disclosed components.

### REFERENCE SIGNS LIST

TX Uninterruptible apparatus at transmission end
RX Uninterruptible apparatus at reception end
U1, U2 User apparatus
NW Relay network
1 Control unit
2 Program storage unit
3 Transmission packet storage unit
4 Reception packet storage unit
5 Transmission interface unit (Transmission I/F)
6 Reception interface unit (Reception I/F)

### 7 Bus

### 10 Transmitter

### 20 Receiver

101 Input order information imparting unit
102 Encoding group control unit
103 Packet duplication unit
104 Source packet FIFO queue
105 Duplicate packet FIFO queue
106 Packet operation unit
107 Encoding source information imparting unit
108 Encoded packet FIFO queue
109 Transmission FIFO queue
110 Transmission order information imparting unit
111 Transmission packet transfer control unit
201 Transmission order information deletion unit
202 Packet identification unit
203 Source packet FIFO queue
204 Duplicate packet FIFO queue
205 Encoded packet FIFO queue
206 Packet operation unit
207 Reception FIFO queue
208 Input order information deletion unit
209 Reception packet transfer control unit

1. A packet communication system configured to transmit a packet from a first communication apparatus to a second communication apparatus via a single communication path of a network, wherein
the first communication apparatus includes
a group generation unit configured to generate one of a plurality of packet groups including a first packet and a second packet based on a packet train that is input,
a packet duplication unit configured to generate, for each of the plurality of packet groups, a first duplicate packet and a second duplicate packet based on the first packet and the second packet included in the one of the plurality of packet groups,
an encoded packet generation unit configured to generate, for each of the plurality of packet groups, an encoded packet based on the second packet and the first duplicate packet, and
a transmission unit configured to transmit the first packet, the second duplicate packet, and the encoded packet to the single communication path, and
the second communication apparatus includes
a reception unit configured to receive the first packet, the second duplicate packet, and the encoded packet that are transmitted via the single communication path,
a decoding unit configured to decode the second packet and the first duplicate packet based on any one of the first packet and the second duplicate packet that are received and the encoded packet that is received, and
a restoring unit configured to restore the first packet and the second packet of the one of the plurality of packet groups based on the first packet and the second duplicate packet that are received and the second packet and the first duplicate packet that are decoded.

2. The packet communication system according to claim 1, wherein the encoded packet generation unit performs packet operation using a linear code to generate the encoded packet expressed by a linear combination of the second packet and the first duplicate packet.

3. The packet communication system according to claim 1, wherein the grouping processing unit configures a packet group including the number of packets corresponding to a time length not below a maximum value of a past occurred interruption time in the network.

4. The packet communication system according to claim 1, wherein
the first communication apparatus further includes
a packet length adjusting unit configured to adjust, in an anterior stage of the grouping processing unit, when a variable-length packet is included in the packet train, a packet length of the variable-length packet to be a preset fixed length.

5. A transmission apparatus configured to transmit a packet to a communication apparatus at a reception end via a single communication path of a network, the transmission apparatus comprising:
a group generation unit configured to generate one of a plurality of packet groups including a first packet and a second packet based on a packet train that is input;
a packet duplication unit configured to generate, for each of the plurality of packet groups, a first duplicate packet and a second duplicate packet based on the first packet and the second packet included in the one of the plurality of packet groups;
an encoded packet generation unit configured to generate, for each of the plurality of packet groups, an encoded packet based on the second packet and the first duplicate packet; and
a transmission unit configured to transmit the first packet, the second duplicate packet, and the encoded packet to the single communication path.

6. A reception apparatus configured to receive a packet transmitted from the transmission apparatus according to claim 5, the reception apparatus comprising:
a reception unit configured to receive the first packet, the second duplicate packet, and the encoded packet that are transmitted from the transmission apparatus via the single communication path;
a decoding unit configured to decode the second packet and the first duplicate packet based on any one of the first packet and the second duplicate packet that are received and the encoded packet that is received; and
a restoring unit configured to restore the first packet and the second packet of the one of the plurality of packet groups based on the first packet and the second duplicate packet that are received and the second packet and the first duplicate packet that are decoded.

7. A program that causes a hardware processor included in the transmission apparatus to perform processing of each unit included in the transmission apparatus according to claim 5.

8. A program that causes a hardware processor included in the reception apparatus to perform processing of each unit included in the reception apparatus according to claim 6.
